(19) United States
(12) Patent Application Publication
(10) Pub. No.: US 2015/0377644 A1
(43) Pub. Date: Dec. 31, 2015

(54) METHOD, SYSTEM, AND COMPUTER-READABLE MEDIUM FOR PLANNING PATH

(71) Applicant: HTC Corporation, Taoyuan County (TW)

(72) Inventors: Chia-Hao CHEN, Taoyuan City (TW); Ying-Chieh LIN, Taoyuan City (TW)

(73) Assignee: HTC Corporation, Taoyuan County (TW)

(21) Appl. No.: 14/314,316

(22) Filed: Jun. 25, 2014

(51) Int. Cl. G01C 21/36

(52) U.S. Cl. CPC G01C 21/3667

(57) ABSTRACT

A method, a system, and a computer-readable medium for planning a path are provided. The method comprises the following steps. A plurality of pictures with geographic information are received from a cloud server. A selection signal selecting at least two of the pictures is received and the geographic information of the selected pictures is obtained. The path is planned according to the geographic information and then displayed on a map.

### TECHNICAL FIELD

The disclosure relates in general to a method, a system, and a computer-readable medium, and more particularly to a method, a system, and a computer-readable medium for planning a path

### BACKGROUND

With the development of Geographic Information System (GIS) technology, varied path planning devices are invented. The path planning device can provided us a best path from a departure place to a destination place.

For planning the path, the user needs to input an address or a name of the destination place. If the user wants to visit several places, he needs to input the addresses or the names of those places one by one. It is not convenient for the user.

### SUMMARY

The disclosure is directed to a method, a system, and a storage device for planning a path. The path is planned according to a plurality of geographic information comprised in a plurality of pictures provided from a cloud server without inputting any address or name.

According to one embodiment, a method for planning a path is provided. The method comprises the following steps. A plurality of pictures with geographic information are received from a cloud server. A selection signal selecting at least two of the pictures is received and the geographic information of the selected pictures is obtained. The path is planned according to the geographic information. The path is displayed on a map.

According to another embodiment, a system for planning a path is provided. The system comprises a picture receiving unit, a data obtaining unit, a path planning unit and a map processing unit. The picture receiving unit is for receiving a plurality of pictures with geographic information received from a cloud server. The data obtaining unit is for receiving a selection signal selecting at least two of the pictures and obtaining the geographic information of the selected pictures. The path planning unit is for planning the path according to the geographic information. The map processing unit is for displaying the path on a map.

According to alternative embodiment, a computer-readable medium containing instructions for performing a method for planning a path is provided. The method comprises the following steps. A plurality of pictures with geographic information are received from a cloud server. A selection signal selecting at least two of the pictures and the geographic information of the selected pictures is obtained. The path is planned according to the geographic information. The path is displayed on a map.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows a system for planning a path;

FIG. 2 shows a flow chart of a method for planning a path; and

FIGS. 3 to 7 show an example of FIG. 2.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

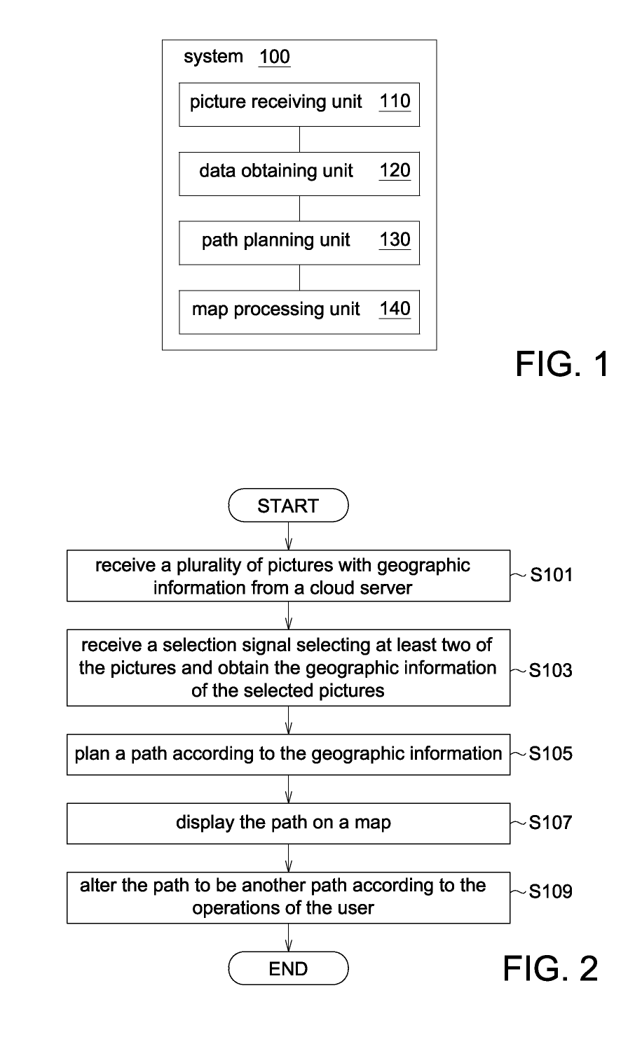

Please referring to FIG. 1, a system 100 for planning a path is shown. The system 100 may be, for example, a server, a portable electronic device, a personal computer, or a combination thereof. In another embodiment, the system 100 may be a combination of a cloud server and a portable electronic device.

The picture receiving unit 110 is used for receiving a plurality of pictures. For example, the picture receiving unit 110 may be a cloud disk, a wireless communicating device connecting a database, a screen on an electronic device and/or a circuit having a function of providing a plurality of pictures.

The data obtaining unit 120 is used for obtaining varied data recorded in the pictures. For example, the data obtaining unit 120 may be a processing chip, a circuit board, a storage medium storing a plurality of program codes, and/or a circuit having a function of obtaining varied data.

The path planning unit 130 is used for planning a path according to varied data. For example, the path planning unit 130 may be a processing chip, a circuit board, a storage medium storing a plurality of program codes, and/or a circuit having a function of planning a path.

The map processing unit 140 is used for planning and displaying a path on a map. For example, the map processing unit 140 may be a screen, a processing chip, a circuit board, a storage medium storing a plurality of program codes, and/or a circuit having a function of showing a path on a map.

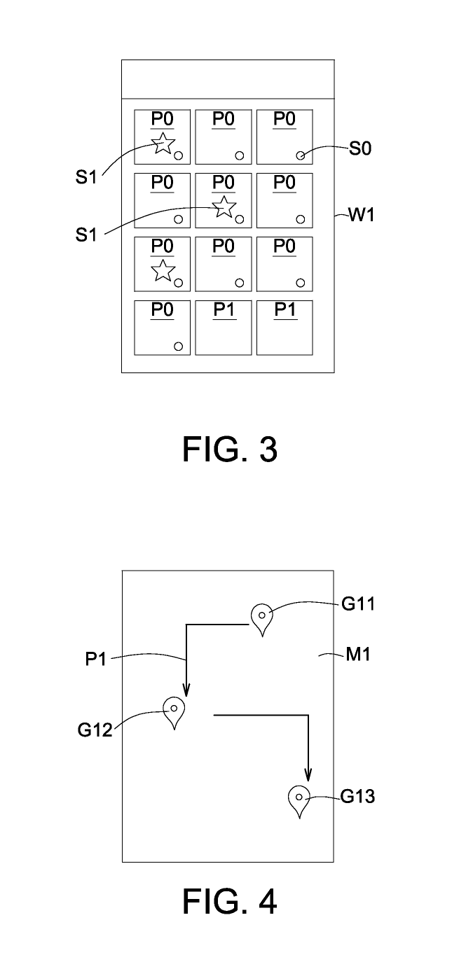

The system 100 can plan a path according to a plurality of geographic information comprised in a plurality of pictures received from a cloud server without inputting any address or name for the stops and destinations. The operation of the system 100 is exemplified according to a flow chart shown in FIG. 2. In another embodiment, the plurality of pictures may be originally received from a cloud server and downloaded to a local storage device. In further another embodiment, the plurality of pictures may be originally stored in a local storage device.

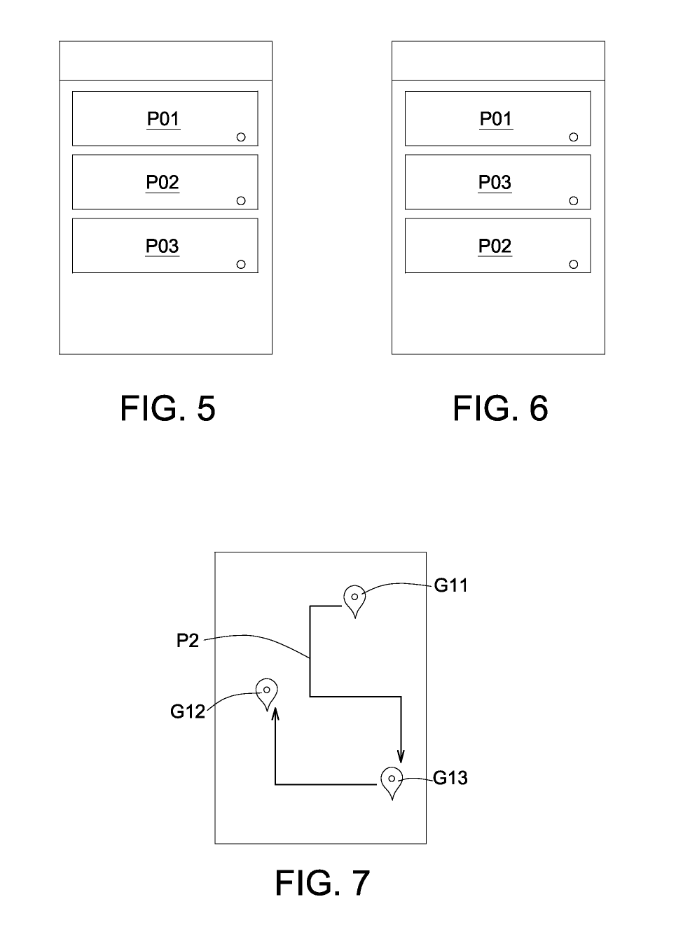

Please referring to FIGS. 2 to 7, FIG. 2 shows a flow chart of a method for planning a path and FIGS. 3 to 7 show an example of FIG. 2. The method for planning a path can be performed by instructions recorded in a computer-readable medium. The computer-readable medium may be a hard disk, a memory, a USB disk, an optical disk, or a cloud disk. In step S101, referring to FIGS. 2 and 3, the picture receiving unit 110 provides a plurality of pictures P0 from a cloud server. The cloud server is a social network service or similar service with photo sharing function on the cloud. The picture P0 may be loaded to a portable device or a personal computer from the photo service, or be browsed on a user interface of an internet browser or a user interface of an application. The geographic information may be longitude and latitude. The geographic information may be added to the picture P0 when the picture P0 is captured with geotagging or added the geotagging information to the picture P0 after the picture P0 is captured. The picture P0 may be a landscape photo, a scenery photo, a building photo, or a photo showing and representing a location that people can identify where the location is according to the photo or according to the description of the photo.

In one embodiment, pictures P0 which comprise the geographic information are marked with symbol S0 and pictures P1 which do not comprise any geographic information are shown on a window W1. The symbol S0 may be, for example, a spot located at a right-bottom corner of each picture P0. In another embodiment, the pictures P1 may also be marked with a symbol for showing that this picture does not comprise the geographic information. The user can identify the pictures P0 with geographic information and the pictures P1 without geographic information via the symbol S0.

In one embodiment, the pictures P1 which do not comprise any geographic information may be filtered out and only the pictures P0 which comprise the geographic information may be shown in the window W1 without marking the symbol S0. For example, after the user launch an application or open a web service and use the path planning function, both pictures P0 and P1 are shown by default. If the user only wants to see the pictures P0, the user can execute an operation to filter out the pictures P1.

The pictures P0 are shown for a user to select. The user can select the pictures P0 representing the locations where the user wants to visit. Then, each of the selected pictures P0 is marked with a sign S1. The sign S1 may be, for example, a star symbol located at the center of each selected pictures P0. For example, referring to FIG. 3, three pictures P0 are selected by the user and marked with the sign S1. In another embodiment, the selected pictures P0 may be highlighted, for example by scumbling the color of the pictures P0, to distinguish from the un-selected pictures P0.

In step S103, referring to FIGS. 2, 3, and 4, the data obtaining unit 120 receives a selection signal selecting at least two of the pictures P0 and obtains the geographic information of the selected pictures P0. For example, three geographic information G11, G12, and G13 are obtained from three selected pictures P0 marked with that star symbols.

In step S105, referring to FIG. 4, the path planning unit 130 plans a path P1 according to the geographic information G11, G12, and G13. In one embodiment, the path planning unit 130 plans the path P1 according to a sequence of the selection of the pictures P0. In another embodiment, the path P1 may be planned according to the relative geographic locations of the selected pictures P0. For example, the sequence to visit each location of the selected pictures P0 may be arranged according to the distance between each of the selected pictures P0 and the starting point and/or the distance between each two selected pictures P0. In still another embodiment, the selected pictures P0 may be collected and arranged in a bar, and the path P1 may be planned according to the sequence of the selected pictures P0 in the bar. Furthermore, the sequence of the selected pictures P0 in the bar may be re-arranged by the user, and then the path P1 may be re-arranged according to the new sequence of the selected pictures P0 in the bar. In particular, the re-arrangement of the path P1 is automatically.

In step S107, referring to FIG. 4, the map processing unit 140 displays the path P1 on a map Ml.

In step S109, referring to FIGS. 5 to 7, the path P1 may be further amended to be another path P2 according to the operations of the user. For example, the user may drag the pictures P01, P02, and/or P03 to change the sequence of the pictures P01, P02, and P03. In FIG. 5, the location of the picture P01 is the first stop, the location of the picture P02 is the second stop, and the location of the picture P03 is the third stop. In FIG. 6, after dragging and re-arranging the pictures P01, P02, and P03 by the user, the location of the picture P01 is the first stop, the location of the picture P03 is the second stop, and the location of the picture P02 is the third stop. In FIG. 7, a path P2 is obtained according to the sequence in FIG. 6.

Base on the above, the user can easy to generate and obtain a planned path when the user is browsing a friend's photo album. The user can easy to get the information of how to visit the same place where those pictures are captured. During the operation of browsing photo album and planning the path, the user does not need to manually input any address of the location of the photo or keyword to get the information of the location of the photo. It is very convenient for the user.

It will be apparent to those skilled in the art that various modifications and variations can be made to the disclosed embodiments. It is intended that the specification and examples be considered as exemplary only, with a true scope of the disclosure being indicated by the following claims and their equivalents.

1. A method for planning a path, comprising:
receiving a plurality of pictures from a cloud server, wherein the plurality of pictures are arranged in a list view, and a subset of the plurality of pictures are marked with a symbol indicating the pictures in the subset contain geographic location information;
receiving a selection signal selecting at least two of the pictures marked with the symbol and obtaining the geographic location information of the selected pictures, wherein the selected at least two of the pictures comprise a first picture and a second picture, and the geographic location information includes at least a first geographic location information corresponding to the first picture and a second geographic location information corresponding to the second picture;
planning the path between the first geographic location information and the second geographic location information; and
displaying the path on a map.

2. (canceled)

3. The method according to claim 1, wherein the symbol is a spot located at a corner of each picture of the subset of the plurality of pictures.

4. The method according to claim 1, wherein each of the selected pictures is marked with a sign.

5. The method according to claim 1, wherein the cloud server is a social network service.

6. The method according to claim 1, wherein the path is planned according to a sequence of the selection of the pictures.

7. The method according to claim 1, wherein the path is planned according to relative geographic locations of the selected pictures.

8. The method according to claim 1, wherein the selected pictures are arranged in a bar, and the path is planned according to the sequence of the arrangement of the selected pictures in the bar.

9. A system for planning a path, comprising:
a picture receiving unit for receiving a plurality of pictures from a cloud server, wherein the plurality of pictures are arranged in a list view, and a subset of the plurality of pictures are marked with a symbol indicating the pictures in the subset contain geographic location information;
a data obtaining unit for receiving a selection signal selecting at least two of the pictures marked with the symbol and obtaining the geographic location information of the selected pictures, wherein the selected at least two of the pictures comprise a first picture and a second picture, and the geographic location information includes at least a first geographic location information corresponding to the first picture and a second geographic location information corresponding to the second picture;
a path planning unit for planning the path between the first geographic location information and the second geographic location information; and
a map processing unit for displaying the path on a map.

10. (canceled)

11. The system according to claim 9, wherein the symbol is a spot located at a corner of each picture of the subset of the plurality of pictures.

12. The system according to claim 9, wherein each of the selected pictures is marked with a sign.

13. The system according to claim 9, wherein the cloud server is a social network service.

14. The system according to claim 9, wherein the path planning unit plans the path according to a sequence of the selection of the pictures.

15. The system according to claim 9, wherein the path is planned according to relative geographic locations of the selected pictures.

16. The system according to claim 9, wherein the path is planned according to relative geographic locations of the selected pictures.

17. A computer-readable medium containing instructions for performing a method for planning a path, the method comprises:
receiving a plurality of pictures from a cloud server, wherein the plurality of pictures are arranged in a list view, and a subset of the plurality of pictures are marked with a symbol indicating the pictures in the subset contain geographic location information;
receiving a selection signal selecting at least two of the pictures marked with the symbol and obtaining the geographic location information of the selected pictures, wherein the selected at least two of the pictures comprise a first picture and a second picture, and the geographic location information includes at least a first geographic location information corresponding to the first picture and a second geographic location information corresponding to the second picture;
planning the path between the first geographic location information and the second geographic location information; and
displaying the path on a map.

18. (canceled)

19. The computer-readable medium according to claim 17, wherein the cloud server is a social network service.

20. The computer-readable medium according to claim 17, wherein the path is planned according to relative geographic locations of the selected pictures.

21. The method according to claim 1, wherein the cloud server is a service with photo sharing function.

22. The system according to claim 9, wherein the cloud server is a service with photo sharing function.

23. The computer-readable medium according to claim 17, wherein the cloud server is a service with photo sharing function.
